(19) United States
(12) Patent Application Publication
(10) Pub. No.: US 2017/0235434 A1
(43) Pub. Date: Aug. 17, 2017

(54) ULTRASONIC ACTUATOR APPARATUS

(71) Applicant: Knowles Electronics, LLC, Itasca, IL (US)

(72) Inventors: Sarmad QUTUB, Des Plaines, IL (US); Martin VOLK, Willowbrook, IL (US)

(73) Assignee: Knowles Electronics, LLC, Itasca, IL (US)

(21) Appl. No.: 15/435,173

(22) Filed: Feb. 16, 2017

Related U.S. Application Data
(60) Provisional application No. 62/296,437, filed on Feb. 17, 2016.

(51) Int. Cl. G06F 3/043; H04R 19/04; B06B 1/06; B06B 1/02

(52) U.S. Cl. CPC G06F 3/0436; B06B 1/0292; H04R 19/04; B06B 1/06; B06B 2201/55; B06B 2201/51; H04R 2201/003; H04R 2499/15

(57) ABSTRACT

An ultrasonic actuation apparatus includes a piezoelectric transducer producing a first ultrasonic signal; a second transducer; and a platen, the platen being directly and/or acoustically coupled to the piezoelectric transducer and the second transducer. The second transducer may be a MEMS microphone. The second transducer is configured to receive the first ultrasonic signal at a first time, and a second ultrasonic signal at second time. The second ultrasonic signal has been modified from the first ultrasonic signal in correspondence with an object being in contact with the platen.

### CROSS-REFERENCE TO RELATED APPLICATIONS

The present application claims priority to U.S. Prov. Appln. No. 62/296,437 filed Feb. 17, 2016, the contents of which are incorporated by reference herein in their entirety.

### TECHNICAL FIELD

This application relates to actuators and, more specifically, to ultrasonic-based actuators.

### BACKGROUND

It is often desirable to enable actuation of devices via a flat surface (e.g. a platen), as such surfaces have desirable industrial and user experience properties, e.g. reduction in design complexity, aesthetics, and ease of cleaning.

Various approaches have been used to sense the touch of an object on or at the platen. Unfortunately, these approaches are often complex and expensive to implement. The problems of previous approaches have resulted in some user dissatisfaction with these previous approaches.

### SUMMARY

The present embodiments relate to enabling actuation via a flat surface through the combination of an active actuator (e.g. a piezoelectric device), combined with a passive microphone (e.g. a micro electro mechanical system (MEMS) microphone), both of which are acoustically coupled to the flat surface. According certain aspects, user interaction with the surface changes the signals that are produced by the actuator and received by the microphone, and enables the development of actuation areas (e.g. button areas) on the flat surface.

A MEMS microphone is designed to pick up acoustic signals, and a MEMS die includes at least one diaphragm and at least one back plate. The MEMS die is supported by a base or substrate and enclosed by a housing (e.g., a cup or cover with walls). A port may extend through the substrate (for a bottom port device) or through the top of the housing (for a top port device). In any case, sound energy traverses through the port, moves the diaphragm and creates a changing potential of the back plate, which creates an electrical signal. Microphones are deployed in various types of devices such as personal computers or cellular phones.

A piezoelectric device is constructed with such materials that bending or application of stress to the piezoelectric device causes the creation of electrical energy. Piezoelectric devices have also been used to transmit signals in a variety of different applications.

The actuation surfaces according to embodiments are general. For example, various types of buttons and switches can be used to perform actuation functions. Sometimes, an area of a platen is touched or contacted by an object (e.g., a user's finger) and this touching actuates the device. For example, a button may be graphically presented on the platen and the user touches the “button” to actuate the device.

### BRIEF DESCRIPTION OF THE DRAWINGS

For a more complete understanding of the disclosure, reference should be made to the following detailed description and accompanying drawings wherein:

FIG. 1 comprises a block diagram showing an apparatus for determining whether an object is in contact with a platen according to various embodiments of the present invention;

FIG. 2 comprises a side cut-away view of an apparatus that is used to determine whether an object is in contact with a platen according to various embodiments of the present invention;

FIG. 3 comprises a top view of the apparatus of FIG. 2 according to various embodiments of the present invention;

FIG. 4 comprises a modified apparatus of FIG. 2 that uses a gasket according to various embodiments of the present invention;

FIG. 5 comprises an approach that can be executed by a processor for determining whether an object is in contact with a platen according to various embodiments of the present invention;

FIG. 6 comprises a top view of an apparatus using a single piezoelectric device and multiple microphones to detect contact in multiple areas of a platen according to various embodiments of the present invention;

FIG. 7 comprises a side cutaway view of the apparatus of FIG. 7 along line A-A according to various embodiments of the present invention;

FIG. 8 comprises a top view of the device of FIG. 6 and FIG. 7 according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches sense the touch, impact, contact, and/or presence of an object on or at a platen. In one example, these approaches sense the touch of the finger of a user on a screen of a device such as a cellular phone or tablet. Other examples are possible. The approaches described herein are easy and cost effective to implement, and reliably sense the touch, presence, or impact of an object on or at the platen.

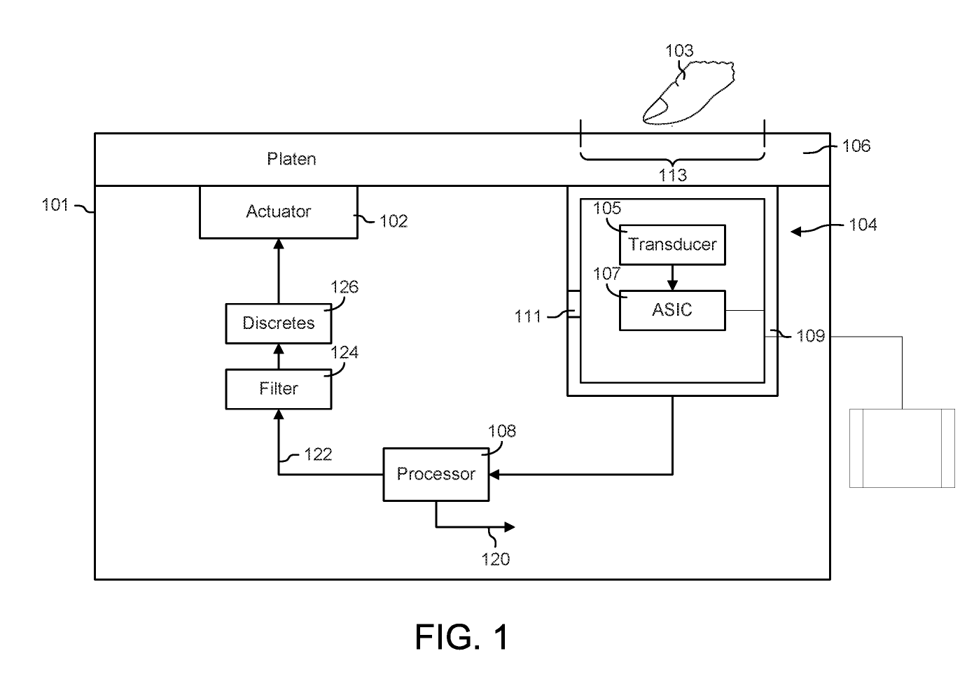

Referring now to FIG. 1, one example of an apparatus that senses the touch, contact, presence or impact of an object at a platen is described. An actuator device 102 and a micro electro mechanical system (MEMS) microphone 104 are coupled to a platen 106 (e.g. by adhesive, clamps, etc.). These devices are disposed within a customer electronics device 101, which in examples may be a refrigerator, oven, microwave, cellular phone, laptop, tablet, personal computer, or similar device. Although actuator device 102 and MEMS microphone 104 are shown directly coupled to the platen 106, this is not necessary in all embodiments. For example, one or both of actuator device 102 and MEMS microphone may be only acoustically coupled to platen 106, as that term is appreciated by those skilled in the art.

In embodiments described herein, the actuator device 102 is configured to only transmit sound energy, specifically ultrasonic signals. Ultrasonic signals consist of sound energy above the human audible hearing range, which is usually at 20 kHz. In one aspect, the ultrasonic signals are in the 20 kHz-200 kHz frequency band. However, other embodiments are not limited to the use of sound energy confined to the ultrasonic ranges, but can include sound energy at least partially in the audible range.

In embodiments, actuator device 102 is a piezoelectric device constructed of piezoelectric materials, or alternating layers of metal and piezoelectric materials. In other embodiments, actuator device 102 is a capacitor with a ceramic that creates the signal/piezo-like effect. In yet other embodiments, actuator device 102 is a MEMS device.

The MEMS microphone 104 is configured to sense acoustic energy and includes a MEMS transducer 105 and an integrated circuit 107 that are disposed within a housing or assembly 109. A port 111 extends through the housing 109. The MEMS transducer 105 includes a die, a back plate, and a diaphragm. Acoustic energy enters the microphone 104 and moves the diaphragm. In some examples, acoustic energy (including ultrasonic signals) is received through the port and housing.

As the diaphragm moves, a changing electrical potential is created with the back plate, creating a signal or current that is representative of the acoustic energy. The signal is sent to the integrated circuit 107 for further processing. This further processing may include buffering the signal or removing undesirable noise. In other aspects, the further processing may include an analysis of signal parameters to determine whether an object is touching the platen 106.

The MEMS microphone 104 is disposed under or adjacent to an area 113 of the platen 106. Although the boundaries of the microphone 104 may not exactly match the boundaries of the area 113, generally speaking the microphone 104 is positioned under the area 113. The area 113 may be presented (e.g., drawn or otherwise indicated on the top surface of the platen 106) as a button or other feature. The area 113 may be of any shape, but in examples is circular or square. Other examples are possible. The area 113 may be graphically indicated (e.g., drawn or etched) on the surface of the platen. For example, a button may be drawn to indicate the area 113. The drawn area may or may not correspond to the exact dimension of the area 113. For instance, the button may be drawn slightly larger or slightly smaller than the area 113. The MEMS microphone 104 detects when an object 103 (e.g., finger, pen, to mention two examples) are in contact with the area 113. In some examples, the piezoelectric transducer may also be included in the region 113 along with the microphone 104.

The platen 106 may be any generally flat and planar object or structure (such as a plate or a screen (or part of a screen)) used on or at a home appliance or consumer electronics device (e.g., a refrigerator, washing machine, oven, cellular phone, tablet, or personal computer).

The platen 106 may be constructed of a wide variety of materials such as metals (e.g., stainless steel), glass, plastic, or combinations of these materials. The platen 106 may be a single-layered structure or include multiple layers of different materials. In examples, the platen 106 may be 0.6 mm or 1 mm thick. Other examples are possible.

The MEMS microphone 104 is coupled to a processor 108. The processor 108 may be a digital signal processor (DSP), a microcontroller, or a codec to mention a few examples. The processor 108 may also be analog electronic devices, such as a comparator. The processor 108 performs processing on the signals received from the MEMS microphone 104. In some aspects, the processing includes an analysis of signal parameters to determine whether the object 103 is touching the platen 106.

It will be appreciated that any type of transducer can be used for the MEMS microphone 104. For example, piezoelectric transducers may also be used.

In one aspect, the processor 108 outputs a first stimulus or control signal 120 and a second stimulus or control signal 122. The first stimulus or control signal is used to control some other processor or device. The second stimulus or control signal 122 controls the piezoelectric device 102. It will be appreciate that other control signals (and data signals) may also be sent from the processor 108.

In one example (and if the device 101 includes a screen) and as shown in FIG. 1, the control signal 120 may be used to change the screen. The second control signal 122 may be sent to a filter 124 (which filters the signal 122) and discrete components 126 (e.g., which may include an amplifier that is used to adjust the voltage of the signal) received from the filter 124. The discrete components 126 drive the piezoelectric device 102. Alternatively, the second control 122 may be omitted and a dedicated oscillator may be coupled to the filter 124 to provide a constant actuation signal to the piezoelectric device 102.

The first control signal 120 may be sent to a host (or other processing device or some other electronic device or component) and indicate an action to take such as activating a device, deactivating a device. In one particular example, the first control signal 120 directly controls the activation of a computer screen. The second control signal 122 may be any type of signal or stimulus such as a sinusoidal waveform or a pseudo random signal. As discussed below and in systems with multiple piezoelectric devices, each piezoelectric device may be driven by a different stimulus (e.g., sinusoidal signals with different frequencies or pseudorandom signals with different numeric sequences).

It will be appreciated that the piezoelectric device 102 may be driven (actuated) constantly (either by an oscillator or by the processor 108) or selectively. Selective actuation may be used to save power. Selective activation may be based, for example, on whether the device 101 has been activated.

In some examples, every microphone is paired with an individual piezoelectric component. In other words, each piezoelectric device transmits to a single microphone. In other examples, each piezoelectric component is coupled to or operates with multiple microphones. That is, the piezoelectric device transmits to multiple microphones.

In some examples using multiple piezoelectric components, different signals (different pseudo-random signals or operated at different sinusoid frequencies) are used to actuate each piezoelectric component. In other examples, all piezoelectric components are identical and stimulated with the identical signals. In some aspects, two or more piezoelectric components with different performance parameters (such as resonant frequencies) are integrated or used in the same system.

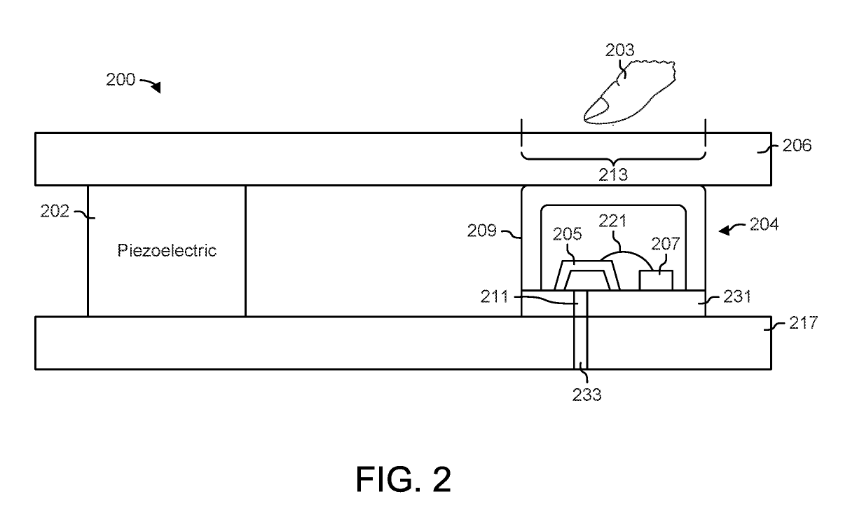

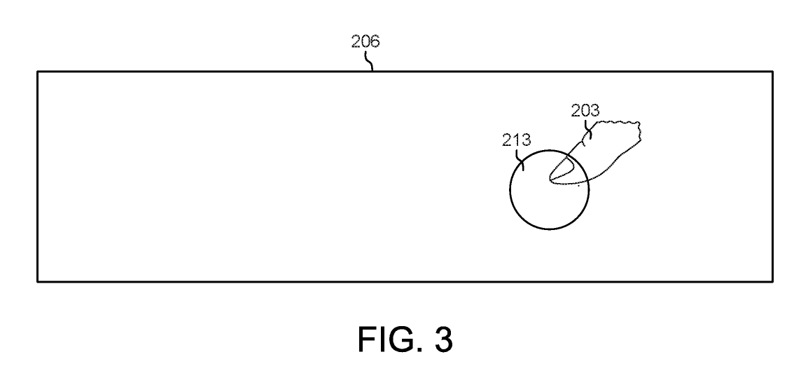

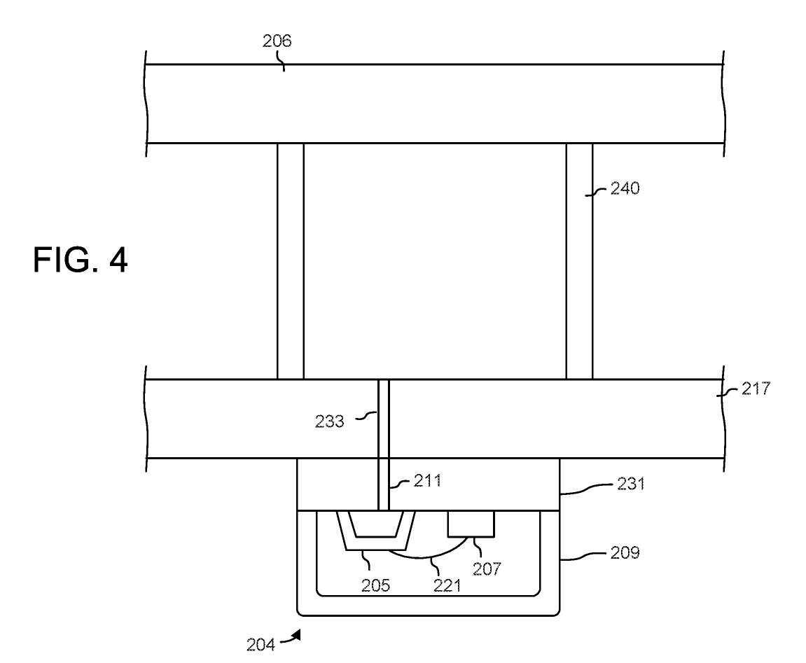

Referring now to FIG. 2, FIG. 3, and FIG. 4 another example of an apparatus 200 that senses the touch, presence or impact at an object at a platen is described. A piezoelectric device 202 and a micro electro mechanical system (MEMS) microphone 204 are directly and/or acoustically coupled to a platen 206, as will be appreciated from the example descriptions below. The apparatus 200 may be disposed within an appliance or customer electronics device.

The piezoelectric device 202 may be constructed of alternating layers of metal and piezoelectric materials. In one example of use, the piezoelectric device 202 is configured to transmit sound energy, specifically ultrasonic signals.

The MEMS microphone 204 is configured to sense acoustic energy and includes a MEMS transducer 205 and an integrated circuit 207 that are disposed on a substrate 231 (e.g., a printed circuit board) and enclosed by a lid or cover 209. A port 211 extends through the substrate 231. Other port orientations are possible out of the top or side for pressure relief as well. The MEMS transducer 205 includes a die, a back plate and a diaphragm. Acoustic energy enters and moves the diaphragm. The acoustic energy sensed by MEMS microphone 204 includes ultrasonic signals produced by the piezoelectric device 202.

It will be appreciated that any type of transducer can be used for the MEMS microphone 204. For example, piezoelectric transducers may also be used.

As the diaphragm moves, a changing electrical potential is created with the back plate, creating a signal or current that is representative of the acoustic energy. The signal is sent to the integrated circuit 207 for further processing (e.g., noise removal) via wires 221. This further processing may include noise removal. In other aspects, the further processing may include an analysis of signal parameters to determine whether an object is touching the platen 206.

The MEMS microphone 204 is disposed under, coupled under, or adjacent to an area 213. Although the boundaries of the microphone 204 may not exactly match the boundaries of the area 213, generally speaking the microphone 204 is positioned under or coupled to the area 213. The area 213 may be presented (e.g., drawn or otherwise indicated on the top surface of the platen 206) as button or other feature. The MEMS microphone 204 detects when an object 203 (e.g., finger, pen, to mention two examples) are in contact with the area 213. In other examples, both the microphone 204 and the piezoelectric device are coupled to or under the area 213.

The piezoelectric device 202 and the MEMS microphone 204 are disposed on a base 217 (e.g., a printed circuit board). In some examples, the base 231 of the microphone may be omitted and only a single base, i.e., base 217, used. In some embodiments, a port 233 also extends through the base 231 and allows sound to enter the microphone 200 through port 211. In these and other embodiments, to prevent unwanted acoustic interference, the port 211 and/or port 233 may be blocked or plugged using an appropriate covering material (e.g. epoxy or tape).

The platen 206 may be any generally flat and planar object such as a screen (or part of a screen) used on a consumer electronics device (e.g., a cellular phone, tablet, or personal computer). The platen 206 may be constructed of a wide variety of materials such as metals (e.g., stainless steel), glass, plastic, or combinations of these materials. The platen 206 may be a single-layered structure or include multiple layers of different materials. In one example, the platen 206 may be 1 mm thick. Other thicknesses are possible.

The MEMS microphone 204 is electrically connected to a processor (not shown, but in one example processor 108 of FIG. 1). The connection may be made using pads on the exterior surface of the base 217. These pads couple to the integrated circuit 207 via conductive paths through the bases 217 and 231.

The processor may be a digital signal processor (DSP), a microcontroller, or a codec to mention a few examples. The processor performs processing on the signals received from the MEMS microphone 204. In some aspects, the processing includes an analysis of signal parameters to determine whether an object is touching the platen 206.

It will be appreciated that the piezoelectric device 202 may be driven (actuated) constantly (either by an oscillator or by a processor) or selectively. Selective actuation may be used to save power. In this case, the selective actuation can be achieved by a processor that selectively actuates the piezoelectric device 202.

Referring now especially to FIG. 4, an alternative to the arrangement of FIGS. 2 and 3 is shown, along with the addition of a gasket 240. The gasket is configured and sized to fit between the platen 206 and the substrate 217. The gasket 240 adds structure and stability to the device 200.

In this alternative arrangement, microphone 204 is a bottom port configuration with port 211 facing platen 206. Acoustic energy is received by microphone 204 through port 211 and port 233, which in this arrangement is not blocked.

If included in the arrangement shown in FIG. 2, the gasket 240 may enclose the microphone 204 and may allow for more accurate positioning of the microphone. In these and other arrangements, a gasket 240 may be used to hold the piezoelectric device. This gasket may be a single gasket housing that the microphone in FIG. 2 is also included in, or it may be a separate gasket in either of the arrangements of FIG. 2 or FIG. 4. It is also possible that both the microphone and piezoelectric device will have independent gaskets. It will be appreciated that a wide variety of different gasket configurations, dimensions, and arrangements are possible.

It will also be understood that the examples of FIGS. 2-4 show a bottom port configuration (that is, the port extends through the base of the substrate) of microphone 204. Top port configurations where the port extends through the cover of the microphone and not through the base can also be used, in which case the cover may be either directly or acoustically coupled to the platen. Side port configurations where the port is oriented to the side of the cover of the microphone structure can also be used.

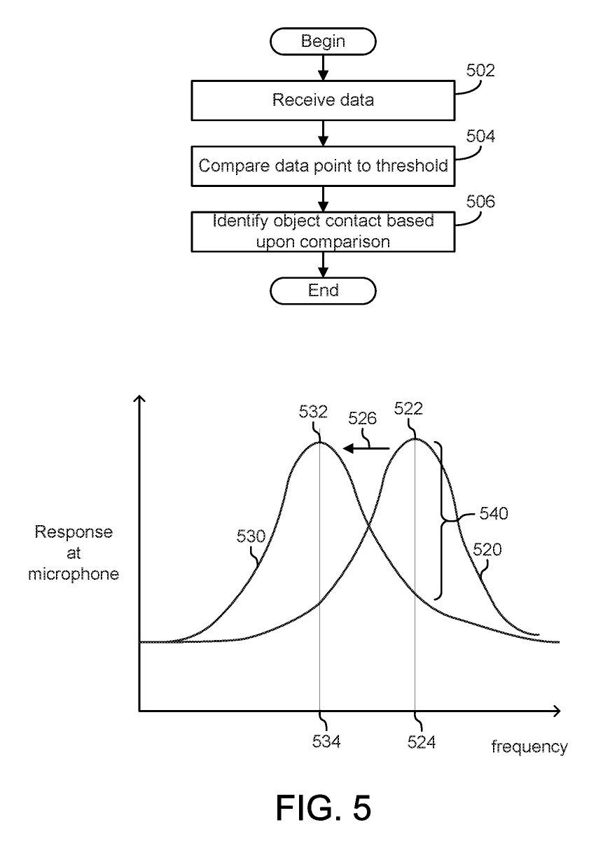

Referring now to FIG. 5, one example of an approach, for example, using a processing device, to determine when an object is in contact with a platen is described. For example, this approach may be performed or executed by an integrated circuit within a microphone assembly (e.g., by the integrated circuit 107 in FIG. 1), or by a processing device that is external to the microphone assembly (e.g., by the processor 108 of FIG. 1).

In a first state, a piezoelectric device transmits an ultrasonic signal. The ultrasonic signal creates a vibration in the platen. No object is touching the platen in this first state. A range of first responses are received at the microphone. An initial or base response curve is formed for the responses received over a range of frequencies. This base response curve is stored at memory, either at a processing device external to the microphone (e.g., processing device 108 of FIG. 1) or at an internal memory of the microphone.

In a second state and at a second time, an object is placed to contact the platen. The piezoelectric device is still transmitting, and a range of second responses are sensed at the microphone. These second responses form a second response curve. The second response curve differs from the initial or base response curve because the presence of an object dampens and/or shifts the resonant frequency of the second curve. As a result of the interaction of the transmitted ultrasonic signals (from the piezoelectric device) with the platen and the object, the transmitted signals are modified and the modified signals received at the microphone. In other examples, the amplitude/response at a single frequency is monitored instead of a range of frequencies.

The characteristics of the second response curve are affected not only by the contact of an object on the platen, but by the amount of force exerted by the object on the platen. Thus, the harder (more force) the object is pressed to the platen, the more the response curve will change (e.g., the more the resonant frequency will shift). In this way, a small amount of force may indicate a first function, while a larger amount of force may indicate a second function to be performed as a result of the button press. Various thresholds can be used to distinguish between functions. Thresholds may be stored in memory at either the microphone or another electronics device (e.g., device 108 in FIG. 1).

It will be understood that the object contact and force of the contact affect the response curve. When the load of the piezoelectric device is increased (via the contact), the resonance point of the response curve moves to a lower frequency.

It will be appreciated that the approaches described herein work with any kind of finger (e.g., wet, dry, dirty, or clean). Cleaning is easier than conventional buttons, since only the surface of the platen need be cleaned. There are no moving components such as springs or coils thereby increasing reliability of these devices compared to previous approaches.

In the present example and in the absence of an object touching the platen in a designated area, a first or base response curve 520 is determined at the microphone with a resonant frequency 524 having amplitude 522 and is stored in the processor 108 or in other examples in the microphone.

An object touching the designated area moves the curve 520 in the direction indicated by the arrow labeled 526 to form new curve 530. The new response curve 530 (obtained when an object is present and touching the platen) has a resonant frequency 534 with peak response 532. It will be understood that the more force applied by the object, the greater the shift of resonant frequency. Thus, a single button can be used to sense multiple functions, with the amount of force indicating the function that is selected or desired.

The response 520 may be stored in a memory at the device performing the determination as to whether an object is touching the platen.

At step 502, data is received. More specifically, data representing the response curve 530 is received. At step 504, a data point is compared to a threshold. For example, the amplitude of curve 530 at frequency 524 is compared to a threshold. In this case, a difference 540 is determined. The response that is observed is due to the shifting of the resonance of the system as indicated in FIG. 5 and also the dampening of the vibration of the signal by an object in contact with a designated microphone/button location.

At step 506, it is determined whether the difference is above a predetermined threshold. The difference threshold may be set by the user, after device testing, or set by the device maker to mention a few examples. If the answer is affirmative (i.e. the difference is above the threshold), then an object is determined to have been detected. If the answer is negative, then no object is detected and no action need be taken. When an object is detected, further actions can occur. For example, one or more control signals can be sent from the processing device to other components at the appliance or consumer device where the processing device is deployed. For example, if the processor is deployed in an appliance or an electronic device with a screen, the screen can be activated. Many other examples are possible.

It also will be appreciated that a comparison between the resonant frequencies 524 and 534 can be made. If the difference is above a predetermined threshold, then an object is determined to be touching the designated area of the platen. Other parameters of these signals can also be used to determine the presence of an object.

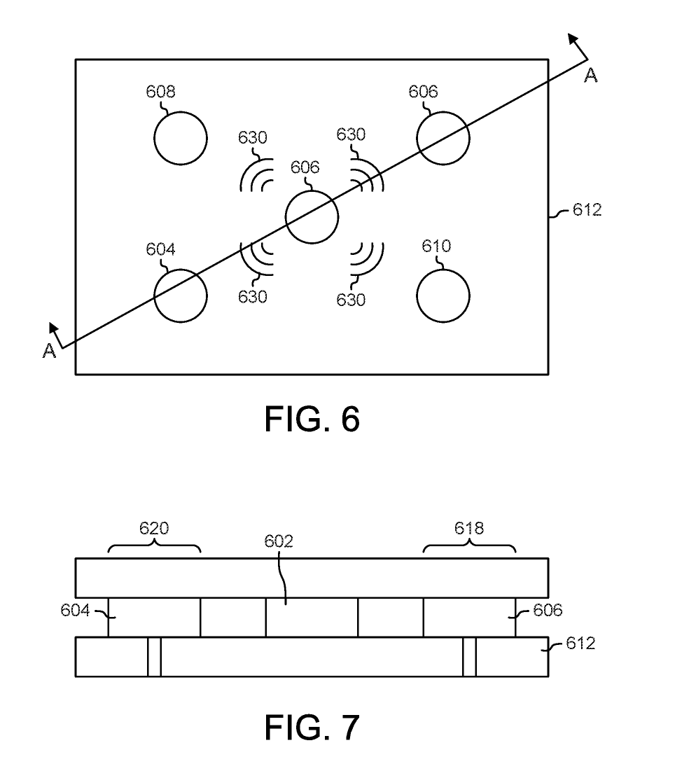

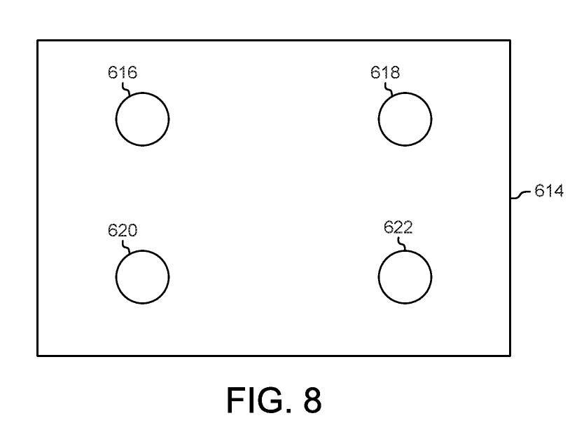

Referring now to FIG. 6, FIG. 7, and FIG. 8, one example of using a piezoelectric device with multiple microphones is described. In this example, a first piezoelectric transducer operates with a plurality of second transducers (e.g., MEMS microphones). A platen is coupled to the piezoelectric transducer and the plurality of second transducers is arranged about the single piezoelectric transducer. The piezoelectric transducer produces a first ultrasonic signal, and each of the plurality of the second transducers are configured to receive second ultrasonic signals. Each of the second ultrasonic signals has been modified from the first ultrasonic signal.

More specifically, a piezoelectric device 602, first MEMS microphone 604, a second MEMS microphone 606, a third MEMS microphone 608, and a fourth MEMS microphone 610 are disposed on a substrate 612. A platen 614 is disposed over this arrangement and includes areas 616, 618, 620, and 622. A processing device (which can be either in the microphones 604, 606, 608, and 610 or a separate device (not shown)) determines for each area 616, 618, 620, and 622 whether an object (e.g., a finger) is in contact with a particular area 616, 618, 620, and 622.

It will be appreciated that the microphones, piezoelectric element, substrate, and platen may be structured as described elsewhere herein and this description will not be repeated here. As mentioned a separate and single processing element may couple to the microphones 604, 606, 608, and 610 and perform the processing that determines whether an object is touching any of the areas 616, 618, 620, and 622.

So configured, the piezoelectric element sends ultrasonic signals 630. These signals as modified by the presence of an object in a particular area are received at each of the microphones 604, 606, 608, and 610. Processing as described herein is performed for each microphone and a determination made as to whether an object is present in each of the areas. Thus, a single piezoelectric device can service multiple microphone sites. In other words, an individual piezoelectric device need not be paired with a dedicated microphone. The ability to use a single piezoelectric device to cover multiple sites (where a determination of touch is made) saves cost and also reduces the size of the apparatus. There may be multiple acceptable ratios of piezoelectric components to microphone components for the layout of a system.

The system of FIGS. 6, 7, and 8 can be further expanded and include further piezoelectric devices. Each of these devices may operate with multiple MEMS microphones. Each of the piezoelectric devices may operate with the same characteristics or with different characteristics. In some aspects, two or more piezoelectric components with different performance parameters (such as resonant frequencies) are integrated in the same system. In other examples, the piezoelectric devices have the same performance parameters.

It will be appreciated that the approaches described herein are flexible. In some examples, every microphone is paired with an individual piezoelectric component. In other examples, each piezoelectric component is coupled to multiple microphones.

In some examples using multiple piezoelectric components, different signals (e.g. different pseudo-random signals, tones at different frequencies, varying sweep parameters, etc.) are used to actuate each piezoelectric component. In other examples, all piezoelectric components are identical and stimulated with the identical signals. In further examples, piezoelectric components are activated sequentially.

Preferred embodiments of this invention are described herein; however, it should be understood that the illustrated embodiments are exemplary only, and should not be taken as limiting the scope of the invention.

What is claimed is:

1. An ultrasonic actuation apparatus, comprising:
a first transducer producing a first ultrasonic signal;
a second transducer;
a platen;
wherein the second transducer is configured to receive the first ultrasonic signal at a first time, and a second ultrasonic signal at second time, the second ultrasonic signal having been modified from the first ultrasonic signal in correspondence with an object being in contact with the platen.

2. The ultrasonic actuation apparatus of claim 1, wherein the second transducer is a micro electro mechanical system (MEMS) microphone.

3. The ultrasonic actuation apparatus of claim 1, wherein the second ultrasonic signal is processed and, based on the processing, a determination is made as to whether the object is in contact with the platen.

4. The ultrasonic actuation apparatus of claim 3, wherein the determination includes computing one or both of an amplitude change and a shifting of resonant frequency of a response at the second transducer.

5. The ultrasonic actuation apparatus of claim 1, wherein the platen includes a designated area for user contact.

6. The ultrasonic actuation apparatus of claim 5, wherein the second transducer is coupled to the platen adjacent to the designated area.

7. The ultrasonic actuation apparatus of claim 5, wherein the first transducer and the second transducer are both coupled to the platen adjacent to the designated area.

8. The ultrasonic actuation apparatus of claim 1, wherein the second transducer is a MEMS microphone and includes a base, a MEMS die disposed on the base, an integrated circuit disposed on the base, and a cover that is coupled to the base and encloses the MEMS die and integrated circuit.

9. The ultrasonic actuation apparatus of claim 1, wherein the second transducer is directly coupled to the platen.

10. The ultrasonic actuation apparatus of claim 1, wherein the second transducer is acoustically coupled, but not directly coupled, to the platen.

11. The ultrasonic actuation apparatus of claim 10, wherein the second transducer is a MEMS microphone and includes a port, and wherein the second transducer is acoustically coupled to the platen via the port.

12. The ultrasonic actuation apparatus of claim 1, further comprising a third transducer producing a third ultrasonic signal coupled to the platen, wherein the first transducer is controlled by a first stimulus for producing the first ultrasonic signal and the third transducer is controlled by a second stimulus for producing the third ultrasonic signal, wherein the first stimulus is unique from the second stimulus.

13. The ultrasonic actuation apparatus of claim 1, further comprising a third transducer producing a third ultrasonic signal coupled to the platen, wherein the first transducer is controlled by a first stimulus for producing the first ultrasonic signal and the third transducer is controlled by a second stimulus for producing the third ultrasonic signal, wherein the first stimulus is the same as the second stimulus.

14. The ultrasonic actuation apparatus of claim 1, wherein the first transducer is a piezoelectric transducer.

15. The ultrasonic actuation apparatus of claim 1, wherein the first transducer is a MEMS transducer.

16. The ultrasonic actuation apparatus of claim 1, wherein the first ultrasonic signal includes sound energy in the audible range.

17. An ultrasonic actuation apparatus, comprising:
at least one first piezoelectric transducer;
a plurality of second transducers;
a platen, the platen being coupled to the at least one first piezoelectric transducer and the plurality of second transducers, the plurality of second transducers being arranged proximate to at least one first piezoelectric transducer;
such that at least one first piezoelectric transducer produces a first ultrasonic signal, and each of the plurality of the second transducers are configured to receive second ultrasonic signals, certain of the second ultrasonic signals having been modified from the first ultrasonic signal in correspondence with an object being in contact with the platen.

17. The ultrasonic actuation apparatus of claim 16, wherein each of the plurality of the second transducers is a micro electro mechanical system (MEMS) microphone that includes a base, a MEMS die disposed on the base, an integrated circuit disposed on the base, and a cover that is coupled to the base and encloses the MEMS die and integrated circuit.

18. The ultrasonic actuation apparatus of claim 16, wherein one or more of the second ultrasonic signals are processed and, based on the processing, a determination is made as to whether the object is in contact with the platen.

19. The ultrasonic actuation apparatus of claim 16, wherein the determination includes comparing one or both of an amplitude change and a shifting of the resonant frequency of a response of one or more of the plurality of second transducers.

20. The ultrasonic actuation apparatus of claim 16, wherein the at least one first piezoelectric transducer is disposed in the center of the plurality of second transducers.

21. The ultrasonic actuation apparatus of claim 16, further comprising a second piezoelectric transducer producing a third ultrasonic signal that is paired with a second plurality of second transducers, wherein the at least one first piezoelectric transducer and the second piezoelectric transducer have different performance characteristics for producing the first and third ultrasonic signals, respectively.

22. A method of sensing a contact with a platen, the method comprising:
transmitting a first ultrasonic signal from a piezoelectric transducer;
receiving a second ultrasonic signal at a second transducer, the second ultrasonic signal having been modified from the first ultrasonic signal;
processing the second ultrasonic signal and, based on the processing, determining whether an object is in contact with the platen.

23. The method of claim 22, wherein the processing includes comparing a difference between resonant frequencies of the first and second ultrasonic signals to a threshold.

24. The method of claim 22, wherein the processing includes comparing a difference between amplitudes of the first and second ultrasonic signals at a predetermined frequency to a threshold.

25. The method of claim 22, further comprising storing a first response associated with the first ultrasonic signal, wherein processing includes computing a second response associated with the second ultrasonic signal, and comparing a difference between one or more parameters of the first and second responses to a threshold.

26. The method of claim 22, further comprising storing a first response associated with the first ultrasonic signal, wherein processing includes:
computing a second response associated with the second ultrasonic signal;
computing a difference between a parameter of the first and second responses;
comparing the difference to different first and second thresholds;
if the difference exceeds the first threshold but does not exceed the second larger threshold, determining a first action is associated with the object being in contact with the platen; and
if the difference exceeds the second larger threshold, determining a different second action is associated with the object being in contact with the platen.

27. The method of claim 26, wherein the parameter comprises one or both of an amplitude at a predetermined frequency and a resonant frequency.

28. The method of claim 26, wherein the first and second actions are contact with the platen with different levels of force.
